(19) United States
(12) Patent Application Publication
(10) Pub. No.: US 2023/0226550 A1
(43) Pub. Date: Jul. 20, 2023

(54) SAMPLE TESTING DEVICE

(71) Applicant: ANALOG DEVICES, INC., Wilmington, MA (US)

(72) Inventors: David Frank Bolognia, Charlestown, MA (US); Jiawen Bai, Brighton, MA (US); Joyce Wu, Somerville, MA (US)

(21) Appl. No.: 18/009,543

(22) PCT Filed: Jun. 10, 2021
(86) PCT No.: PCT/US2021/036825

§ 371 Date: Dec. 9, 2022

Related U.S. Application Data
(60) Provisional application No. 63/038,666, filed on Jun. 12, 2020.

(51) Int. Cl. B01L 3/00

(52) U.S. Cl. CPC B01L 3/5029; B01L 2200/16; B01L 2300/043; B01L 2300/0645; B01L 2300/0663; B01L 2300/0832

(57) ABSTRACT

A sample testing device is disclosed. The sample testing device can include a first compartment that is configured to receive a test sample, a second compartment that is configured to receive the test sample, a separator that is disposed between and separating the first compartment and the second compartment, and a mechanical lock structure that is configured to lock and unlock a movement of the separator. When the mechanical lock is unlocked, the separator opens to transfer the test sample from the first compartment to the second compartment. The sample testing device can include a sensing assembly.

### CROSS-REFERENCE TO RELATED APPLICATIONS

This application claims the benefit of U.S. Provisional Application No. 63/038,666 entitled “SAMPLE TESTING DEVICE,” filed Jun. 12, 2020, the entire disclosure of which is incorporated herein by reference for all purposes.

### BACKGROUND

### Field

The field relates generally to sample testing devices.

### Description of the Related Art

A sample testing device can be used to detect various biological species such as SARS-CoV-2 (the virus which causes COVID-19) in a fluid test sample. However, existing testing devices are large, and testing may be time-consuming. There is a continuing need for improved sample testing devices.

### SUMMARY

In one aspect, a sample testing device is disclosed. The sample testing device can include a first compartment that is configured to receive a test sample, a second compartment that is configured to receive the test sample from the first compartment, a separator that is disposed between and separating the first compartment and the second compartment, and a mechanical lock structure that is configured to lock and unlock a movement of the separator. When the mechanical lock is unlocked, the separator opens to transfer the test sample from the first compartment to the second compartment.

In one embodiment, the mechanical lock structure includes a locking clip that locks a first compartment housing that at least partially defines the first compartment in position.

In one embodiment, the sample testing device further includes a sensing element that includes a sensing side and a buffer side opposite the sensing side. The sensing side can be exposed to the second compartment. The sensing element can include a silicon sensing element. The sensing side can have a plurality of electrodes exposed to the second compartment. The sensing element can include a plurality of nanopores. The plurality of electrodes can be disposed about the plurality of nanopores. The plurality of nanopores of the sensing element can include a functionalized layer. The sample testing device can further include a buffer reservoir that is configured to receive a control material. The buffer side of the sensing element can be exposed to the buffer reservoir.

In one embodiment, the sample testing device further includes an air vent channel that is in communication with the second compartment. The air vent channel can be configured to vent out air in the second compartment as the test sample flows into the second compartment.

In one aspect, a sensing device is disclosed. the sensing device can include a sensing element that has a sensing side and a buffer side, a sample reservoir on the sensing side of the sensing element, a buffer reservoir on the buffer side of the sensing element, and an activation feature. The sample reservoir is configured to receive a test sample. The buffer reservoir contains a control material disposed therein. The activation feature is configured to initiate sensing of the test sample.

In one embodiment, the activation feature is configured to initiate sensing of the test sample in response to connecting a reader to the sensing device.

In one aspect, a sensing device is disclosed. The sensing device can include a compartment housing and a cartridge housing. The compartment housing at least partially defines a compartment that is configured to receive a test sample. The cartridge housing is configured to receive the compartment housing and a sensor assembly that has a sample side and a buffer side. The cartridge housing at least partially defines a sample reservoir on the sample side of the sensor assembly. The compartment and the sample reservoir are separated by a separator in a first state. The compartment and the sample reservoir are in fluid communication in a second state.

In one embodiment, the sensor assembly includes a frame structure. A sensing element can be mounted to the frame structure. A printed circuit board can be electrically coupled with the sensing element.

In one aspect, a sensor assembly is disclosed. The sensor assembly can include a substrate that has a first side, a second side opposite the first side, and a through hole that extends from the first side to the second side. The sensor assembly can also include a sensing element that has a sample side and a buffer side opposite the sample side. The sample side of the sensing element is mounted to the first side of the substrate. The sensor assembly can further include a working electrode that is disposed on the second side of the substrate. The working electrode is disposed at least partially about the through hole.

In one embodiment, the sample side of the sensing element is configured to contact a test sample. The buffer side can be configured to contact a control material. The sensing element can include a plurality of nanopores through the sensing element and a plurality of cavities on the buffer side. Each of the plurality of nanopores can include a functionalized layer.

In one embodiment, the sensor assembly can include an adhesion layer that is disposed between the substrate and the sensing element.

In one embodiment, the sensing element includes no electrical interconnect.

In one embodiment, the sensor assembly further includes a reference electrode on the second side of the substrate.

In one embodiment, the sensor assembly further includes a counter electrode on the first side of the substrate.

In one embodiment, the sensor assembly further includes an electrical component that is mounted on the substrate.

In one embodiment, the substrate is a flexible substrate.

In one embodiment, the sensing element includes silicon.

In one embodiment, a sample testing device can include a first compartment that is configured to receive a test sample, a second compartment that is configured to receive the test sample from the first compartment and the sensor assembly that is disposed in the second compartment. The sample testing device can further include a separator that is disposed between and separating the first compartment and the second compartment. The separator can open to transfer the test sample from the first compartment to the second compartment.

### BRIEF DESCRIPTION OF THE DRAWINGS

FIG. 1A is a schematic perspective view of a sample testing device according to an embodiment.

FIG. 1B is a schematic bottom plan view of the sample testing device illustrated in FIG. 1A.

FIG. 2A is a schematic cross-sectional side view of the sample testing device of FIG. 1A in a first state (a closed or locked state).

FIG. 2B is a schematic cross-sectional side view of the sample testing device of FIG. 1A in a second state (an opened or unlocked state).

FIG. 3 is a schematic perspective view of the sample testing device of FIG. 1A near a sensor assembly of the sample testing device showing an air vent flow.

FIG. 4A is a schematic cross-sectional side view of the sensor assembly of the sample testing device of FIG. 1A.

FIG. 4B is a schematic perspective view of the sensor assembly as seen from a sensing side.

FIG. 4C is a schematic perspective view of the sensor assembly as seen from a buffer side.

FIG. 5 is a schematic perspective view of the sensor assembly.

FIG. 6A is a side view of the mechanical locking structure having an unplugged physical status and an open circuit status.

FIG. 6B is a side view of the mechanical locking structure having a plugged physical status.

FIG. 6C is a side view of the mechanical locking structure having a turned physical status.

FIG. 7A is a schematic cross-sectional side view of a sample testing device in a step in a sample testing process.

FIG. 7B is a schematic cross-sectional side view of a sample testing device in another step in the process.

FIG. 7C is a schematic cross-sectional side view of a sample testing device in another step in the process.

FIG. 7D is a schematic cross-sectional side view of a sample testing device in another step in the process.

FIG. 7E is a schematic cross-sectional side view of a sample testing device in another step in the process.

FIG. 7F is a schematic cross-sectional side view of a sample testing device in another step in the process.

FIG. 8A is a schematic exploded view of a sensor assembly having a substrate, a sensing element, and an adhesion layer, according to another embodiment.

FIG. 8B is a schematic perspective top view of the sensor assembly of FIG. 8A without the sensing element and the adhesion layer.

FIG. 8C is a schematic perspective bottom view of the sensor assembly of FIG. 8A without the sensing element and the adhesion layer.

FIG. 8D is a schematic cross-sectional side view of a portion of the sensor assembly of FIG. 8A.

FIG. 8E is a schematic perspective view of a plurality of electrodes of the sensor assembly of FIG. 8A.

### DESCRIPTION

A sample testing device can include a sensing device for sensing properties of a chemical, e.g., a fluid substance such as a biological fluid. In some embodiments, the sample testing device can be used for detecting a biomolecule in a fluid substance, by sensing a bacteria or a virus, for example, influenza, SARS-CoV-2 (the virus which causes COVID-19), or any other suitable micro-organism. The testing device can be used to detect any suitable type of biological substance or micro-organism. Various embodiments disclosed herein relate to a sample testing device. In some embodiments, the sample testing device can comprise a sensing device. In some embodiments, the sample testing device can comprise a testing tube that receives a biological fluid substance for testing.

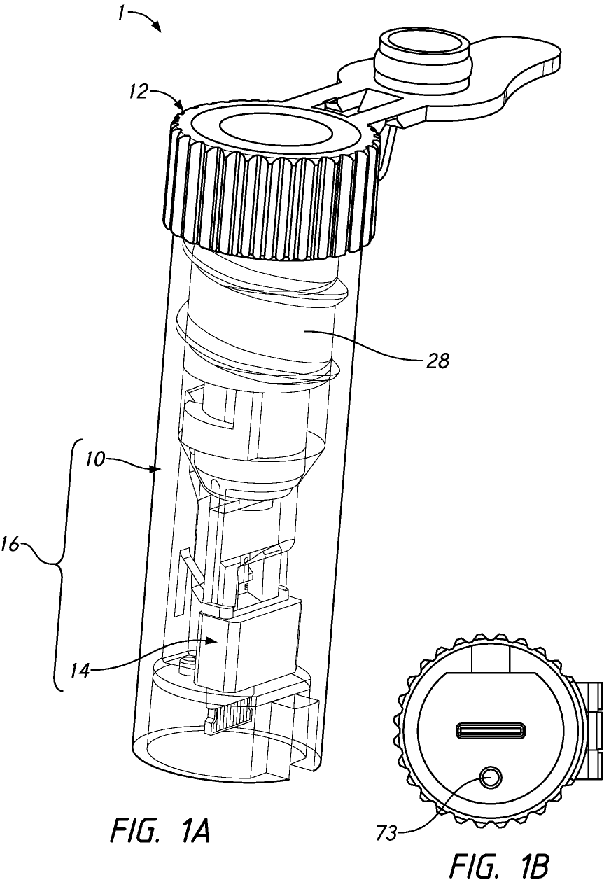

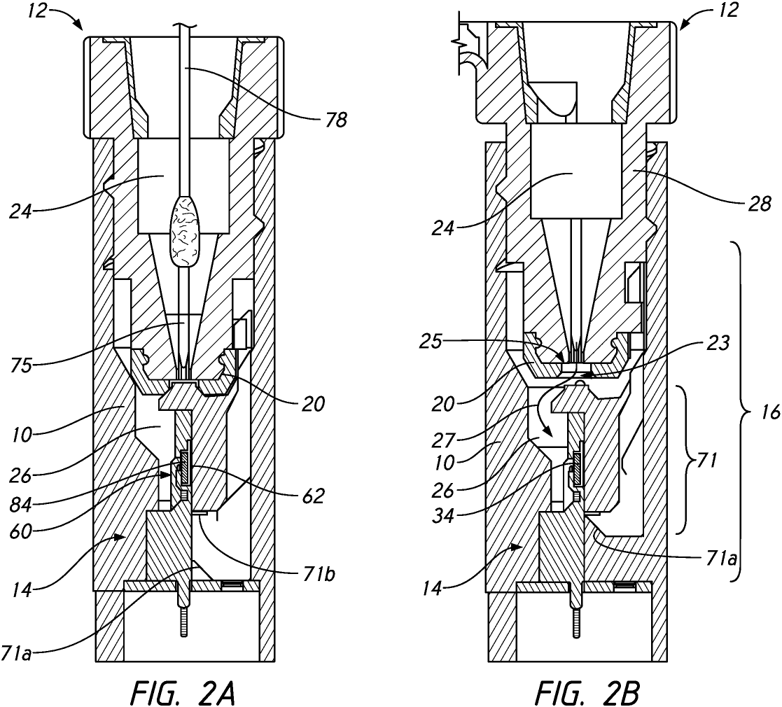

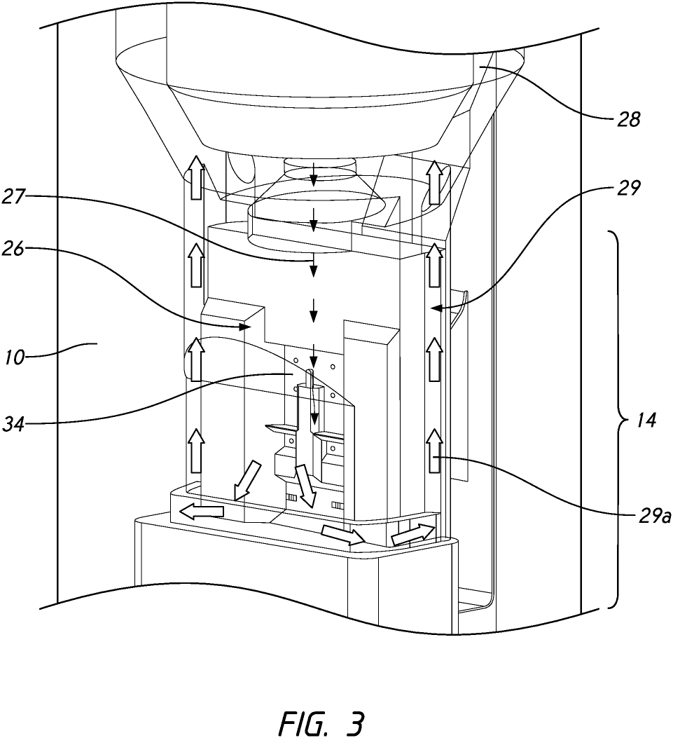

FIG. 1A is a schematic perspective view of a sample testing device 1 according to an embodiment. FIG. 1B is a schematic bottom plan view of the sample testing device 1 illustrated in FIG. 1A. FIG. 2A is a schematic cross-sectional side view of the sample testing device 1 in a first state (a closed or locked state). FIG. 2B is a schematic cross-sectional side view of the sample testing device 1 in a second state (an opened or unlocked state). In some embodiments, the sample testing device 1 can comprise a testing tube. The testing tube can include a cartridge housing 10, a cap 12, a sensor assembly 14 having a sensing element 34, a mechanical locking structure 16, and an activation feature 71. In some embodiments, the activation feature 71 can comprise a lock clip 71a and a detect pin 71b. The sample testing device 1 can include an unlock button 73 that is disposed on a bottom side of the test sampling device 1. A separator 20 can separate the testing tube into a plurality of (e.g., two) compartments. In some embodiments, the separator 20 can comprise an internal sealing gasket (not illustrated). In some embodiments, one of the two compartments can comprise a first sample mixing compartment 24 and the other one of the two compartments can comprise a second sensing compartment 26. The sample mixing compartment 24 can be defined at least in part by a sample mixing compartment housing 28. The sensing compartment 26 can be defined at least in part by the cartridge housing 10. The sample mixing compartment housing 24 can be coupled to the cap 12. The sample mixing compartment 24 can include a solution 75 prior to providing a test sample into the sample mixing compartment. The test sample can be delivered to the sample mixing compartment 24 using, for example, a swab 78. In some embodiments, the test sample can be mixed with the solution 75. In some embodiments, the separator 20 can open to allow fluid communication between the sample mixing compartment 24 and the sensing compartment 26. Therefore, the separator 20 can have the closed state in which there is no fluid communication between the sample mixing compartment 24 and the sensing compartment 26, and the opened state in which there is fluid communication between the sample mixing compartment 24 and the sensing compartment 26. In some embodiments, the separator 20 can open in response to a force applied to the sample testing device 1. For example, the separator 20 can open when the sample mixing compartment housing 28 and/or the cap 12 is twisted relative to the sensing compartment 30. The test sample can be transferred from the sample mixing compartment 24 to the sensing compartment 26 through an aperture 25 when the separator 20 is in the opened state. When the separator 20 is raised above a flange 23 (a part of the cartridge housing 10 that closes the hole), the aperture 25 enables the liquid sample to flow from the sample mixing compartment 24 to the sensing compartment 26 as shown in FIG. 2B as a liquid flow 27.

FIG. 3 is a schematic perspective view of the sample testing device 1 near the sensor assembly 14 showing an air vent flow 29a in a vent channel 29. When the separator 20 is in the opened state and fluid communication between the sample mixing compartment 24 and the sensing compartment 26 is made, the liquid sample can flow in the liquid flow 27 and the air in the sensing compartment 26 can vent out through the vent channel 29 as shown in FIG. 3. The vent channel 29 can facilitate and/or improve the liquid flow 27 in the sensing compartment 26.

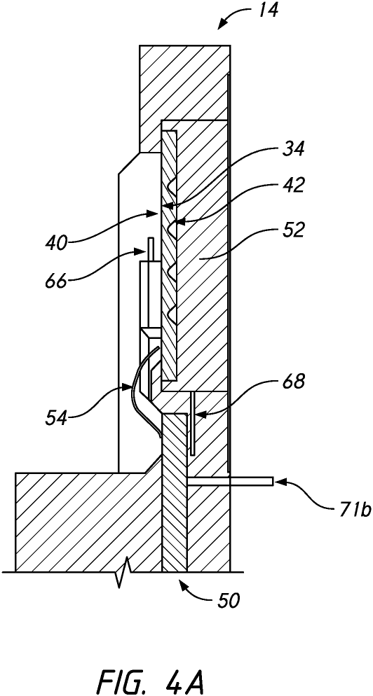

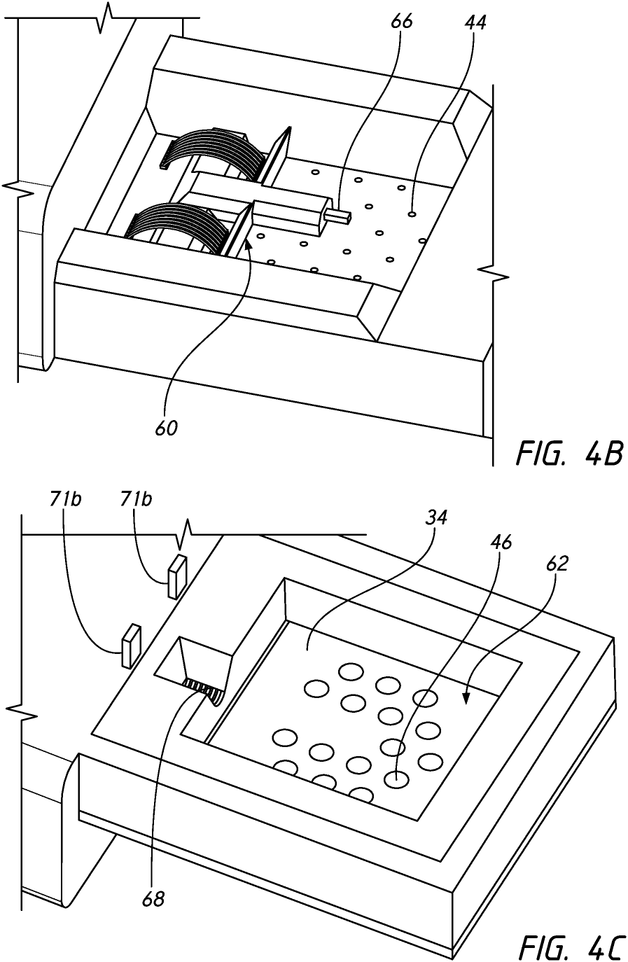

FIG. 4A is a schematic cross-sectional side view of the sensor assembly 14 of the sample testing device 1. FIG. 4B is a schematic perspective view of the sensor assembly 14 as seen from a sensing side 40. FIG. 4C is a schematic perspective view of the sensor assembly 14 as seen from a buffer side 42. FIG. 5 is a schematic perspective view of the sensor assembly 14. The sensor assembly 14 can comprise a sensing element 34. In some embodiments, the sensing element 34 can comprise a semiconductor (e.g., silicon) sensing element. The sensing element 34 can have the sensing side 40 or a sample side that makes contact with or is otherwise exposed to the test sample, and the buffer side 42 or a control side that is opposite the sensing side. The sensing element 34 can have a thickness of about 300 µm. For example, the thickness of the sensing element can be in a range of 150 µm to 450 µm, 250 µm to 450 µm, 150 µm to 350 µm, or 250 µm to 350 µm. In some embodiments, the sensing side 40 of the sensing element 34 can comprise a plurality of electrodes 44. In some embodiments, there can be sixteen electrodes on the sensing side 40 of the sensing element 34, but it should be appreciated that any suitable number of electrodes can be provided. The plurality of electrodes 44 can comprise any suitable material. For example, the plurality of electrodes 44 can comprise platinum (Pt). In some embodiments, the sensing element comprises a plurality of nanopores. The plurality of electrodes 44 can be disposed about the plurality of nanopores. For example, the electrode 44 can be disposed at least partially around the nanopore (e.g., disposed only about a portion of a perimeter of the nanopore, or completely around a nanopore. In some embodiments, each of the plurality of electrodes 44 can comprise two to several hundred nanopores. The plurality of nanopores can extend through a thickness of the sensing element 34. The buffer side 42 of the sensing element 34 can have cavities 46. The cavities 46 can be, for example, about 100 µm to 500 µm deep, or 200 µm to 400 µm deep. In some embodiments, the cavities 46 can comprise through holes that extend through an entire thickness of the sensing element 34. In some embodiments, the plurality of nanopores of the sensing element 34 can also comprise a functionalized layer, such as a biologic layer (e.g., including protein(s)), suitable for detecting a target chemical or biomolecule. In some embodiments, the protein layer can comprise a plurality of portions and each of the plurality of portions of the protein layer can be spotted in each nanopore of the plurality of nanopores. In some embodiments, each set of nanopores can have a different protein. For example, different protein can be used to detect different biological species, such as SARS-CoV-2 (the virus which causes COVID-19), rhinovirus, or any other suitable biological species.

The sensor assembly 14 can also include a package substrate 50 (e.g., a printed circuit board (PCB)), and a frame structure 52. In some embodiments, the package substrate 50 can be insert molded into the frame structure 52. In some embodiments, the frame structure 52 can comprise a medical grade acrylonitrile butadiene styrene (ABS) material. The sensing element 34 can be mounted to the frame structure 52 and electrically connected with the package substrate 50. For example, a portion of the sensing side 40 of the sensing element 34 can be bonded to the frame structure 52. In some embodiments, the sensing element 34 and the package substrate 50 can be electrically connected by way of bonding wires 54. In some other embodiments, the sensing element 34 can be electrically connected to the substrate 50 in another suitable manner. For example, the sensing element 34 can be flip-chip mounted to the substrate 50. For example, an anisotropic conductive paste (ACP) can be used to bond the sensing element 34 to the substrate 50. The package substrate 50 can be in electrical connection with the plurality of electrodes 44 on the sensing side 40 of the sensing element 34 by way of the bonding wires 54 and conductive lines or traces (not illustrated) formed on or in the sensing element 34.

The sensor assembly 14 can also comprise a sample reservoir 60 on the sensing side 40 of the sensing element 34 and a buffer reservoir 62 on the buffer side 42 of the sensing element 34. In some embodiments, the sensing compartment 26 can comprise and/or fluidly communicate with the sample reservoir 60. The sample reservoir 60 can receive the test sample from the mixing compartment 24 when the separator 20 is moved to the open position. The buffer reservoir 62 can hold a control material (e.g., a control liquid). In some embodiments, the control liquid can comprise a phosphate buffer saline (PBS). In some embodiments, the solution 75 that is mixed with the test sample and the control material can be the same. The sample reservoir 60 and the buffer reservoir 62 can be separated at least in part by the sensing element 34.

The sensing element 34 can measure a current through the plurality of nanopores. The current measured when the test sample is present in the sample reservoir 60 and the current measured when the test sample is not in the sample reservoir 60 can be compared to determine the presence of target molecules in the test sample. For example, voltage can be applied across the plurality of nanopores, and the changes in current measured through the plurality of nanopores can be analyzed to determine the presence of target molecules in the test sample. In some embodiments, the plurality of nanopores can comprise nanopores with different sizes, different shapes to enable testing of different probe molecules in one device. The current can be analyzed to monitor disturbance in the current, and determine a result of the testing. In some embodiments, a voltage source can generate a square-wave first at a voltage of -400 millivolts (mV), then at -200 mV, at 0 mV, and at +200 mV. Each specific pair of probe and target molecule can have a specific voltage at which they will bind. This changes the electrical characteristics of the nanopore opening, which alters the current, for example, at -200 mV. The change in the detected current can indicate that the target molecules are binding to the probe molecules in the presence of the -200 mV electric field, so the target molecules that bind to probe molecules at -200 mV are present in the sample. Two or more nanopores may test the same liquid sample or different liquid samples. The plurality of nanopores may be identical, or some or all of the plurality of set of nanopores may be different from each other. For example, the plurality of nanopores may have different sizes, different shapes, different numbers of nanopores, nanopores with different sizes or shapes, or nanopores with different probe molecules. Including different nanopores on a single sensing element 34 enables sensing element 34 to perform multiple different tests, e.g., to test for multiple different target molecules, to test with different sensitivities, or to include controls to verify the accuracy. For example, the testing results can include whether a person from whom the test sample is obtained is infected by a biological pathogen (e.g., a bacteria, virus, etc.) The sensor assembly 14 can test the test sample relatively quickly and accurately. Additional descriptions of a sensing element and sensing mechanism can be found in U.S. Pat. Application Publication No. 2020/0326325, the entire disclosure of which is incorporated herein by reference for all purposes.

The sensor assembly 14 can also include a reference electrode 66 at least partially exposed to the sample reservoir 60, and a counter electrode 68 at least partially exposed to the buffer reservoir 62. The reference electrode 66 and the counter electrode 68 can comprise any suitable materials. In some embodiments, the reference electrode 66 can comprise silver (Ag), silver chloride (AgCl), or the like material. For example, the reference electrode 66 can comprise silver (Ag) and silver chloride (AgCl) as separate layers. In some embodiments, the counter electrode 68 can comprise platinum (Pt), silver (Ag), or Gold (Au). The reference electrode 66, the electrode on the sensing element 34 (e.g., a working electrode), and the counter electrode 68 can be used to monitor the disturbance in the current measured through the working electrode 44. For example, the reference electrode 66 and the counter electrode 68 can monitor voltage to maintain the voltage applied across the nanopores.

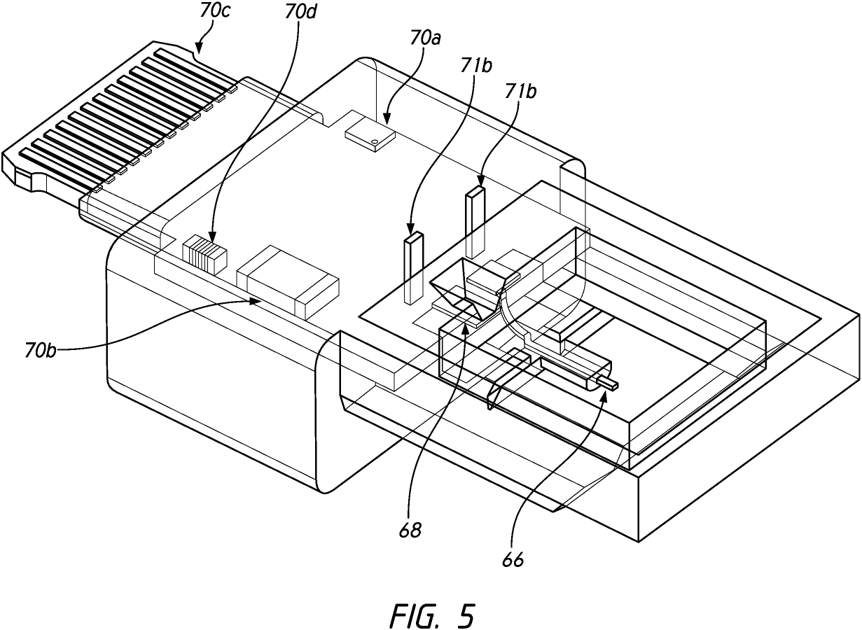

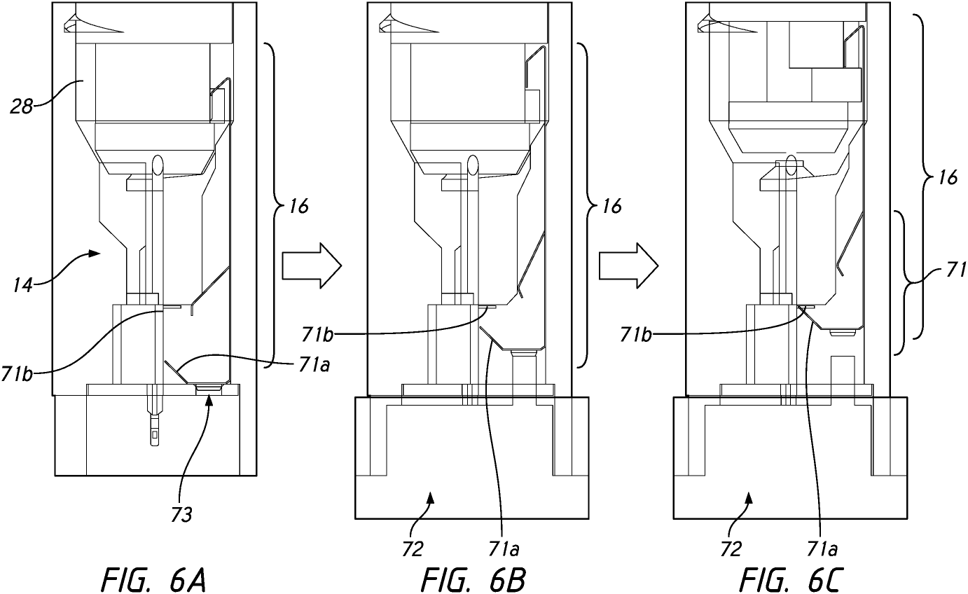

The sensor assembly 14 can further comprise electronic components, such as a memory (e.g., a wafer-level chip size package (WLCSP) electrically erasable programmable read-only memory (EEROM) 70a), a thermometer (e.g., resistance thermometer (RTD) 70b), a connector (e.g., USB connector 70c), a resistor 70d, etc. The processing electronics can be on an external computing device that receives the data by way of the reader 72. Alternatively, the processing electronics can be in the sensor assembly 14, or in the reader 72. In some embodiments, the thermometer can measure temperature of the test sample and/or the control material, thereby allowing the sensing assembly 14 to compensate for the temperature during analysis. In some embodiments, the sensor assembly 14 can be connected to an external device (e.g., a reader 72, shown in FIGS. 6B-6C) through the connector 70c. When the reader 72 is coupled to the sensor assembly 14, the resistor can sense that the reader 72 is coupled thereby unlocking the mechanical locking structure 16 and/or activating the sensing assembly 14. In some embodiments, when the reader 72 is coupled to the test sampling device 1, the mechanical locking structure 16 can be unlocked. The reader 72 can push an unlock button 73 (see FIG. 1B) that is disposed on a bottom side of the test sampling device 1. A force can be applied to the sample mixing compartment housing 28 and/or the cap 12 to cause a mechanical movement. In some embodiments, the sample mixing compartment housing 28 can be moved relative to the cartridge housing 10. For example, the sample mixing compartment housing 28 and/or the cap 12 can be twisted or rotated relative to one another. In such embodiments, the cartridge housing 10 can comprise a female thread and the sample mixing compartment housing 28 can comprise a male thread, or vice versa. When the mechanical locking structure 16 is unlocked, an activation feature 71 can be enabled and the reader 72 can sense resistance in a circuit from the resistor of the sensor assembly 14. The activation feature 71 can include a lock clip 71a and a detect pin 71b that engages/disengages in response to coupling the sample testing device 1 to the reader 72 and/or the twisting action. In response to the twist of sample mixing compartment housing 28 and/or the cap 12, the separator 20 can open to allow the test sample to flow from the sample mixing compartment 24 to the sensing compartment 26 or the sample reservoir 60 by way of the aperture 25 in the fluid flow 27. When the separator 20 opens, the reader 72 can detect a shortage in the circuit. When the short circuit is detected, the reader 72 can initiate reading and analyzing sensed data received from the sensor assembly 14. Table 1 below shows an example relationship between the mechanical movement of the sample mixing compartment and electrical status of the circuit.

TABLE 1

Logic Table

| | |
|---|---|
| Physical Status | Circuit Status |
| Unplugged | Open |
| Plugged | Resistant |
| Plugged and turned | Short |

In some embodiments, the testing tube can comprise a mechanical locking structure 16. For example, the mechanical locking structure 16 can comprise a pin 16a that can restrict movement of the cap 12. The mechanical locking structure 16 can be unlocked when the reader 72 is inserted and the cap 12 is lifted relative to the mechanical locking structure 16 (see FIGS. 6A-6C).

FIGS. 6A-6C are side views of the mechanical locking structure 16 with the three statuses in Table 1. FIG. 6A is a side view of the mechanical locking structure 16 having an unplugged physical status and an open circuit status. In other words, a lock clip 71a and a detect pin 71b of an activation feature 71 is not in electrical contact with each other. FIG. 6B is a side view of the mechanical locking structure 16 having a plugged physical status. in the plugged state of FIG. 6B, the reader 72 senses resistance in a circuit from the resistor 70d of the sensor assembly 14 in the plugged physical status. FIG. 6C is a side view of the mechanical locking structure 16 having a plugged and turned physical status. The sample mixing compartment housing 28 and/or the cap 12 can be twisted relative to the sensing compartment 30, and the lock clip 71a of the activation feature 71 can be lifted to make contact with the detect pin 71b of the activation feature 71. Due to the contact between the lock clip 71a and the detect pin 71b, the reader 72 can detect a short in the circuit in the turned physical status when the lock clip 71a makes contact with the detect pin 71b. The reader 72 can receive data from the sensor assembly 14 of the sample testing device 1. In some embodiments, the reader 72 can analyze the data and determine the components of the fluid sample.

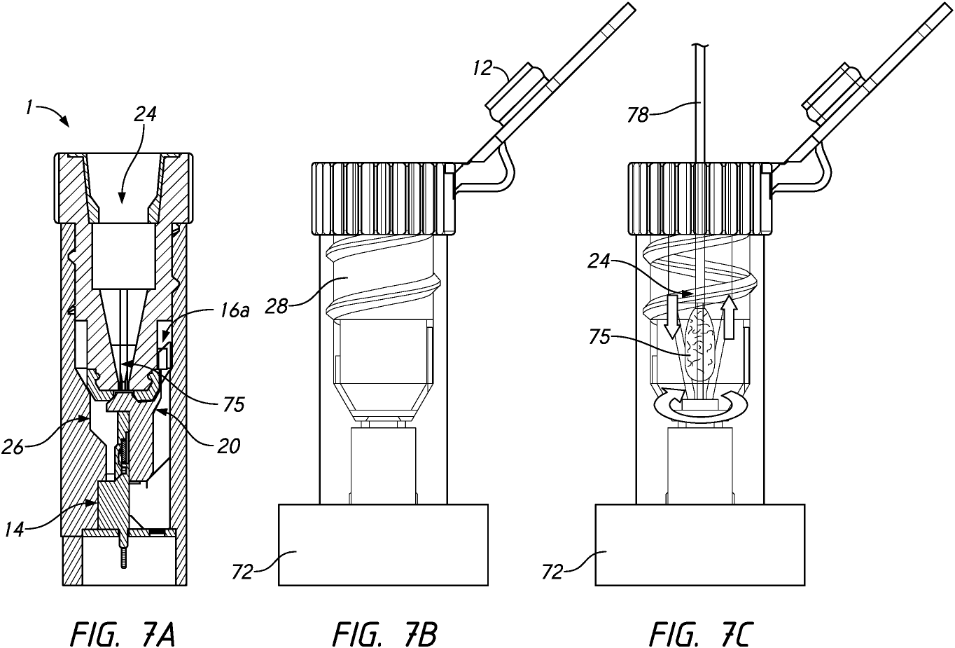

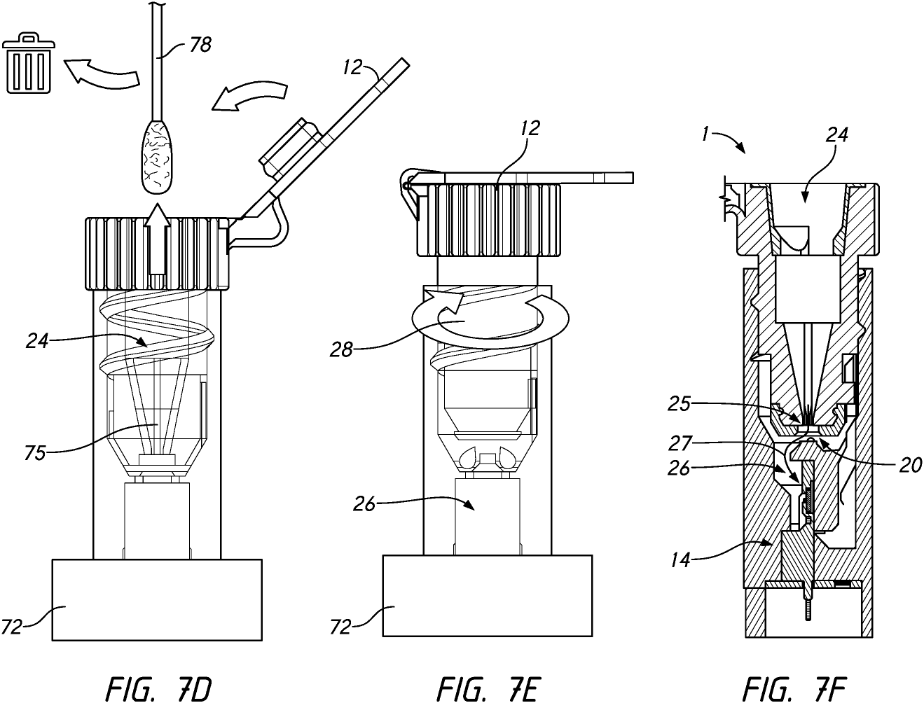

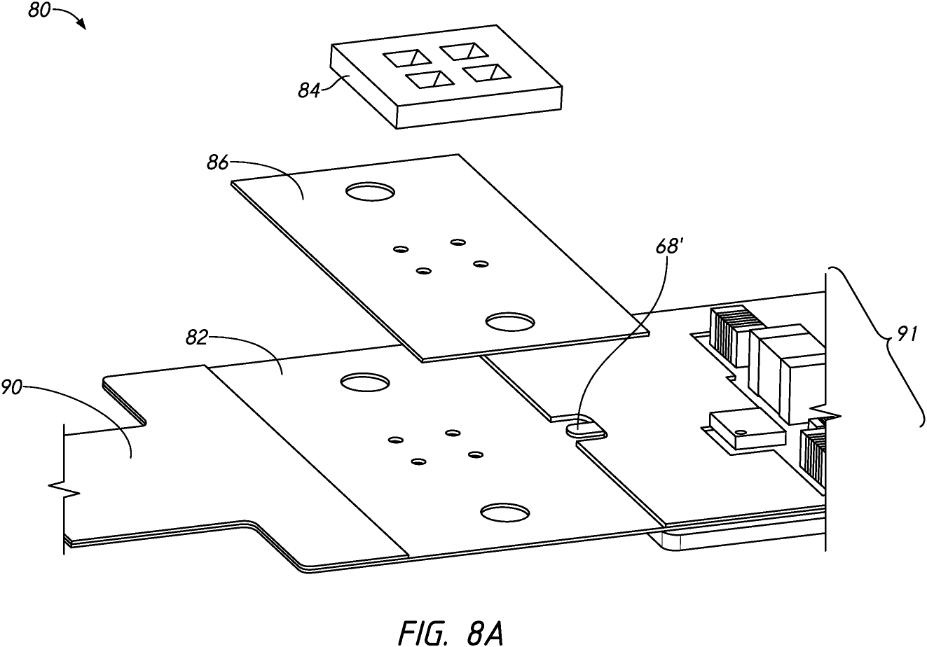

FIGS. 7A-7F show various steps in a process of testing a sample, according to an embodiment. FIG. 7A is a schematic cross-sectional side view of a sample testing device 1 in a step in the process. In FIG. 7A, a solution 75 can be provided in the sample mixing compartment 24. In the step of FIG. 7A, the sample testing device 1 is in the unplugged state, with the circuit indicating an open circuit status. FIG. 7B is a schematic side view of the sample testing device 1 in a step in the process. The sample testing device 1 can be plugged into a reader 72. A cap 12 of the sample testing device 1 can be opened for receiving a test sample. In FIG. 7B, the sample testing device 1 has moved to the plugged state, with the circuit indicating a resistance. FIG. 7C is a schematic side see-through view of the sample testing device 1 with a swab 78 in a step in the process. The test sample can be provided by way of the swab 78. The test sample can be mixed with the solution 75 in the sample mixing compartment 24. For example, the swab 78 with the test sample can be inserted into the sample mixing compartment 24 and stirred with the solution 75. FIG. 7D is a schematic side see-through view of the sample testing device 1 with the swab 78 in a step in the process. At FIG. 7D, the swab 78 can be removed or pulled out from the sample mixing compartment 24. The swab 78 can be discarded after removing the swab 78 from the sample mixing compartment 24, and the cap 12 can be closed. FIG. 7E is a schematic side see-through view of the sample testing device 1 in a step in the process. At FIG. 7E, the sample mixing compartment housing 28 and/or the cap 12 can be twisted relative to the sensing compartment 26. For example, the sample mixing compartment housing 28 and/or the cap 12 can be twisted by a one-fourth turn relative to the sensing compartment 26. In some embodiments, a separator 20 can open in response to the twist to be in an opened state. The test sample can transfer from the sample mixing compartment 24 to the sensing compartment 26 when the separator 20 is in the opened state. In FIG. 7E, the device 1 has moved to a plugged and turn state, in which the circuit indicates a short circuit condition. A sensing element 34 in the sample testing device 1 can sense the test sample and the reader 72 can start reading sensed data. FIG. 7F is a schematic cross-sectional side view of the sample testing device 1 after testing or detecting the test sample. The sample testing device 1 can be removed or unplugged from the reader 72, and the sample testing device 1 can be discarded.

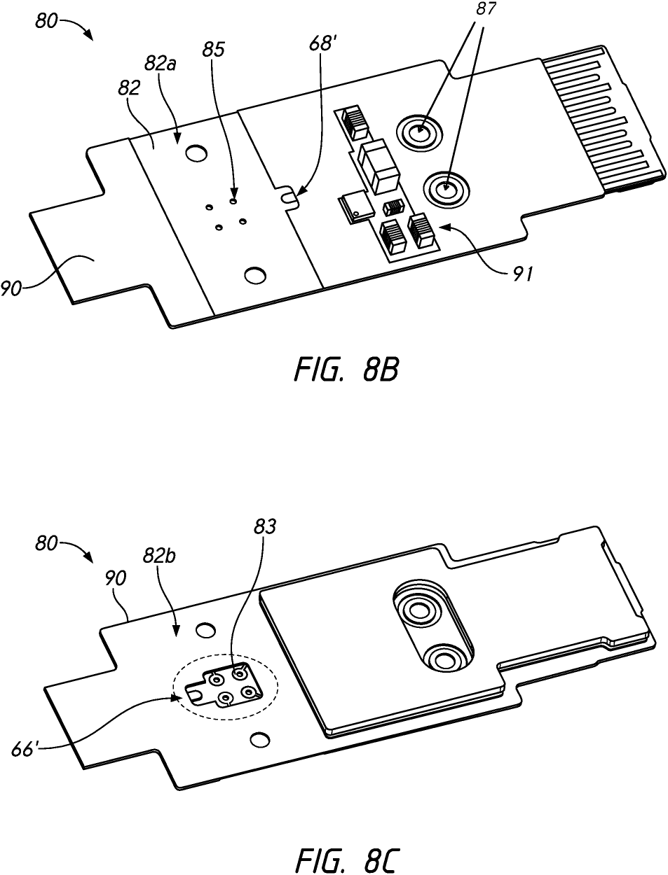

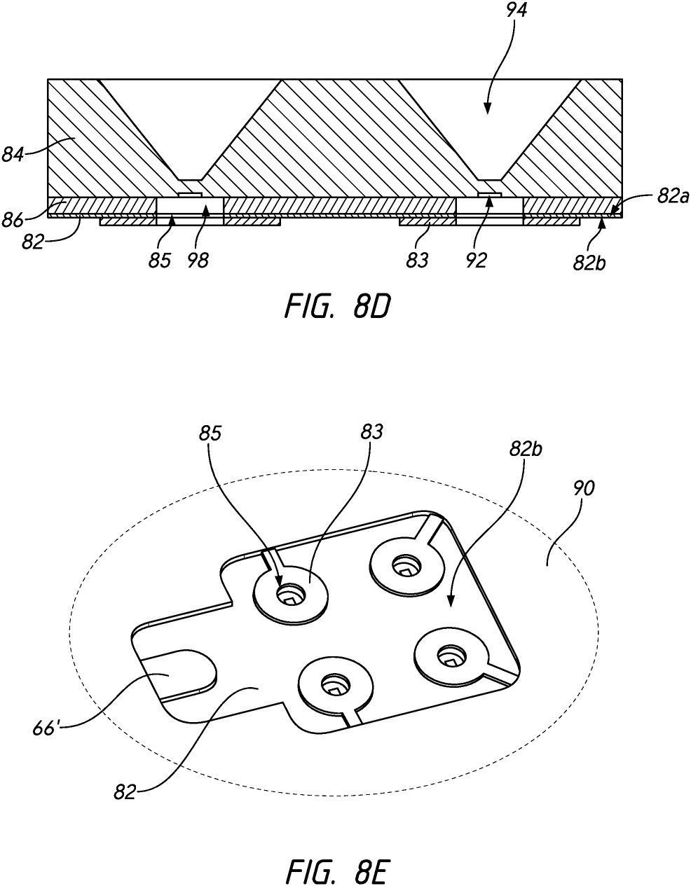

FIGS. 8A-8E are various views of a sensor assembly 80 according to an embodiment. FIG. 8A is a schematic exploded view of the sensor assembly 80 having a substrate 82, a sensing element 84, and an adhesion layer 86. FIG. 8B is a schematic perspective top view of the sensor assembly 80 without the sensing element 84 and the adhesion layer 86. FIG. 8C is a schematic perspective bottom view of the sensor assembly 80 without the sensing element 84 and the adhesion layer 86. FIG. 8D is a schematic cross-sectional side view of a portion of the sensor assembly 80. FIG. 8E is a schematic perspective view of a plurality of electrodes 83 of the sensor assembly 80. In some embodiments, the sensor assembly 80 can be used in the sample testing device 1 described above in place of the sensor assembly 14.

The sensor assembly 80 can include the substrate 82, a sensing element 84 that is coupled to a first side 82a the substrate 82 by way of an adhesion layer 86, a cover layer 90 over the substrate 82. The sensor assembly 80 can include electronic components 91 mounted on the substrate 82. The electronic components, 91 can comprise, for example, a memory (e.g., a wafer-level chip size package (WLCSP) electrically erasable programmable read-only memory (EEROM)), a thermometer (e.g., resistance thermometer (RTD)), a connector (e.g., USB connector), a resistor, etc. The substrate 82 can include the plurality of electrodes 83 on a second side 82b of the substrate 82 opposite the first side 82a.

In some embodiments, the substrate 82 can comprise a flexible substrate. For example, the substrate 82 can comprise a polyimide flexible substrate including a nonconductive material and a plurality of embedded metal traces, a printed circuit board (PCB), a lead frame (e.g., a pre-molded lead frame) substrate, a ceramic substrate, etc.

The substrate 82 can comprise a plurality of electrodes 83 formed on the second side 82b of the substrate 82. The plurality of electrodes 83 can function as working electrodes. The plurality of electrodes 83 can comprise a conductive material. In some embodiments, the plurality of electrodes 83 can comprise platinum. In some embodiments the plurality of electrodes 83 can comprise a ring of conductive material disposed around a hole 85 in the substrate 82. The substrate 82 can also comprise through holes 87. Detect pins (not shown) can go through the through holes 87.

The substrate can comprise a reference electrode 66′ that is formed on the second side 82b of the substrate 82, and a counter electrode 68′ on the first side 82a of the substrate 82. The reference electrode 66′ can at least partially be exposed to a sample reservoir, and the counter electrode 68′ can at least partially be exposed to a buffer reservoir. The reference electrode 66′ and the counter electrode 68′ can comprise any suitable materials. In some embodiments, the reference electrode 66′ can comprise silver (Ag), silver chloride (AgCl), or the like material. In some embodiments, the counter electrode 68′ can comprise platinum (Pt), silver (Ag), or Gold (Au).. In some embodiments the counter electrode 68′ can be electrically grounded. The reference electrode 66′, the plurality of electrodes 83, and the counter electrode 68′ can be used to monitor the disturbance in the current measured through the plurality of electrodes 83. The reference electrode 66′ can sense bulk properties of the test sample and the counter electrode 68′ can sense bulk properties of the control material. The control material can short the counter electrode 68′.

The sensing element 84 can comprise a semiconductor (e.g., silicon) die. In some embodiments, the sensing element 84 can comprise a bare die. In some embodiments, the sensing element 84 includes no electrical interconnect, no active circuitry, and/or no metal therein or thereon. Such a sensing element 84 that does not include an electrical interconnect and/or active circuitry can be manufactured with fewer steps relative to a similar sensing element with an electrical interconnect and/or circuitry formed therein or thereon. In some embodiments, the sensing element 84 can comprise a plurality of nanopores 92. The plurality of nanopores 92 can extend through a portion of a thickness of the sensing element 34. The sensing element 34 can measure a current through the plurality of nanopores 92.

The sensing element 84 can comprise cavities 94 and a protein layer (not shown) in the cavities 94. In some embodiments, the protein layer can comprise a plurality of portions and each of the plurality of portions of the protein layer can be spotted in each nanopore of the plurality of nanopores 92. In some embodiments, each cavity of the cavities 94 can have different protein in order to detect different biological species. The cavities 94 can be exposed to the control liquid.

In some embodiments, the adhesion layer 86 can comprise a double sided tape. The adhesion layer 86 can include a plurality of holes 98 through a thickness of the adhesion layer 86. The holes 98 in the adhesion layer 86, the holes 85 in the substrate 82, and the plurality of nanopores 92 can align with each other. The plurality of nanopores 92 can be exposed to a sample reservoir 60 through the holes 98 in the adhesion layer 86, the holes 85 in the substrate 82. When the sample liquid is provided into the sample reservoir 60, the nanopores 92 can contact the sample liquids.

As compared to a sensing element that includes an electrical interconnect or circuitry, the sensing element 84 can be manufactured with fewer fabrication steps and/or have smaller size. The substrate 82 with the plurality of electrodes 83 can enable the sensor assembly 80 to include such a sensing element (e.g., the sensing element 84) that does not include an electrical interconnect or circuitry. In some embodiments, the substrate 82 can provide improved reliability because the plurality of electrodes 83 can be provided directly on the substrate 82. The sensing assembly 80 can be implemented and used in a similar manner as the sensing assembly 14. In some embodiments, the sensing assembly 80 can detect a composition of a test sample in a similar process as disclosed in FIGS. 7A-7F.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The word “coupled,” as generally used herein, refers to two or more elements that may be either directly coupled to each other, or coupled by way of one or more intermediate elements. Likewise, the word “connected,” as generally used herein, refers to two or more elements that may be either directly connected, or connected by way of one or more intermediate elements. Additionally, the words “herein,” “above,” and words of similar import, when used in this application, shall refer to this application as a whole and not to any particular portions of this application. Where the context permits, words in the above Detailed Description using the singular or plural number may also include the plural or singular number respectively. Where the context permits, the word “or” in reference to a list of two or more items is intended to cover all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

For purposes of summarizing the disclosed embodiments and the advantages achieved over the prior art, certain objects and advantages have been described herein. Of course, it is to be understood that not necessarily all such objects or advantages may be achieved in accordance with any particular embodiment. Thus, for example, those skilled in the art will recognize that the disclosed implementations may be embodied or carried out in a manner that achieves or optimizes one advantage or group of advantages as taught or suggested herein without necessarily achieving other objects or advantages as may be taught or suggested herein.

All of these embodiments are intended to be within the scope of this disclosure. These and other embodiments will become readily apparent to those skilled in the art from the following detailed description of the embodiments having reference to the attached figures, the claims not being limited to any particular embodiment(s) disclosed. Although this certain embodiments and examples have been disclosed herein, it will be understood by those skilled in the art that the disclosed implementations extend beyond the specifically disclosed embodiments to other alternative embodiments and/or uses and obvious modifications and equivalents thereof. In addition, while several variations have been shown and described in detail, other modifications will be readily apparent to those of skill in the art based upon this disclosure. It is also contemplated that various combinations or sub-combinations of the specific features and aspects of the embodiments may be made and still fall within the scope. It should be understood that various features and aspects of the disclosed embodiments can be combined with, or substituted for, one another in order to form varying modes of the disclosed implementations. For example, circuit blocks described herein may be deleted, moved, added, subdivided, combined, and/or modified. Each of these circuit blocks may be implemented in a variety of different ways. Thus, it is intended that the scope of the subject matter herein disclosed should not be limited by the particular disclosed embodiments described above, but should be determined by a fair reading of the claims that follow.

What is claimed is:

1. A sample testing device comprising:
a first compartment configured to receive a test sample;
a second compartment configured to receive the test sample from the first compartment;
a separator disposed between and separating the first compartment and the second compartment; and
a mechanical lock structure configured to lock and unlock a movement of the separator,
wherein when the mechanical lock is unlocked, the separator opens to transfer the test sample from the first compartment to the second compartment.

2. The sample testing device of claim 1, wherein the mechanical lock structure comprises a locking clip that locks a first compartment housing that at least partially defines the first compartment in position.

3. The sample testing device of claim 1, further comprising a sensing element including a sensing side and a buffer side opposite the sensing side, the sensing side exposed to the second compartment.

4. The sample testing device of claim 3, wherein the sensing element comprises a silicon sensing element.

5. The sample testing device of claim 3, the sensing side has a plurality of electrodes exposed to the second compartment.

6. The sample testing device of claim 5, wherein the sensing element comprises a plurality of nanopores, the plurality of electrodes are disposed about the plurality of nanopores.

7. The sample testing device of claim 5, wherein the plurality of nanopores of the sensing element includes a functionalized layer.

8. The sample testing device of claim 1, further comprising an air vent channel in communication with the second compartment, wherein the air vent channel is configured to vent out air in the second compartment as the test sample flows into the second compartment.

9. A sensing device comprising:
a sensing element having a sensing side and a buffer side;
a sample reservoir on the sensing side of the sensing element, the sample reservoir configured to receive a test sample;
a buffer reservoir on the buffer side of the sensing element, the buffer reservoir containing a control material disposed therein; and
an activation feature configured to initiate sensing of the test sample.

10. The sensing device of claim 9, wherein the activation feature is configured to initiate sensing of the test sample in response to connecting a reader to the sensing device.

11. A sensor assembly comprising:
a substrate having a first side, a second side opposite the first side, and a through hole extending from the first side to the second side;
a sensing element having a sample side and a buffer side opposite the sample side, the sample side of the sensing element mounted to the first side of the substrate; and
a working electrode disposed on the second side of the substrate, the working electrode disposed at least partially about the through hole.

12. The sensor assembly of claim 11, wherein the sample side of the sensing element is configured to contact a test sample, and the buffer side is configured to contact a control material, and wherein the sensing element comprises a plurality of nanopores through the sensing element and a plurality of cavities on the buffer side.

13. The sensor assembly of claim 12, wherein each of the plurality of nanopores comprises a functionalized layer.

14. The sensor assembly of claim 11, further comprising an adhesion layer disposed between the substrate and the sensing element.

15. The sensor assembly of claim 11, wherein the sensing element includes no electrical interconnect.

16. The sensor assembly of claim 11, further comprising an electrical component mounted on the substrate.

17. The sensor assembly of claim 11, wherein the substrate is a flexible substrate.

18. The sensor assembly of claim 11, wherein the sensing element comprises silicon.

19. A sample testing device comprising:
a first compartment configured to receive a test sample;
a second compartment configured to receive the test sample from the first compartment; and
wherein the sensor assembly of claim 11 is disposed in the second compartment.

20. The sample testing device of claims 19, further comprising a separator disposed between and separating the first compartment and the second compartment, wherein the separator opens to transfer the test sample from the first compartment to the second compartment.
